(19) United States
(12) Patent Application Publication
(10) Pub. No.: US 2016/0333941 A1
(43) Pub. Date: Nov. 17, 2016

(54) STREAMLINED TRANSMISSION ASSEMBLY

(71) Applicant: Conroe Machine, LLC, Conroe, TX (US)

(72) Inventor: MURRAY JOHN TOUCHETTE, JR., Montgomery, TX (US)

(73) Assignee: Conroe Machine, LLC, Conroe, TX (US)

(21) Appl. No.: 15/153,913

(22) Filed: May 13, 2016

Related U.S. Application Data
(60) Provisional application No. 62/162,519, filed on May 15, 2015.

(51) Int. Cl. F16D 3/223; E21B 3/00; E21B 7/06; E21B 4/02; E21B 17/05; F16D 3/84; E21B 4/00

(52) U.S. Cl. CPC F16D 3/223; F16D 3/845; E21B 3/00; E21B 4/003; E21B 4/02; E21B 17/05; E21B 7/06

(57) ABSTRACT

A Streamlined Transmission assembly is used to convert eccentric rotation created by the power section into concentric rotation to be received by a bearing assembly in order to drive the rotation of a drill bit attached to a drilling assembly section of a downhole tool. The Streamlined Transmission assembly can be configured with a joint that can alter the angle of the bottom hole assembly by the use of a bent housing section while maintaining the capability to transfer large torque loads. The joint of the bent housing section of the assembly is configured to decrease deterioration of a lower seal boot and wash in the lower joint by reducing the volume of turbulent flow adjacent to each structure.

### BACKGROUND

Downhole transmission assemblies have been known in the oil & gas industry for some time. Transmission assemblies are employed to convert the eccentric rotation created by a downhole power section (such as a rotor and stator) into concentric rotation to be received by a bearing assembly in order to drive the rotation of a drill bit. Transmission assemblies often alter the angle of the lower portion of the bottom hole assembly by use of a bent housing section. For example, U.S. Pat. Nos. 4,772,246 to Wenzel and 5,267,905 to Wenzel et al. are illustrative of prior art downhole transmission assemblies. Such assemblies had a drive shaft extending between universal joint assemblies that allowed for some relative movement or pivoting movement of the drive shaft. Such an arrangement helped to facilitate the transfer of torque between a downhole power section and a drill bit. Transmission assemblies must be fairly robust in order to accommodate the thrust load and torque from the rotor caused by pressure drops across the power section.

It has been desirable to improve the robustness and reliability of downhole transmission assemblies. Transmission assemblies also benefit from the ability to more efficiently transfer fluid flow from the power section assembly of the upper portion of the bottom hole assembly. Further, it has also been desirable to improve the transfer of increasing amounts of torque without substantially sacrificing mobility or strength in high degree bent housings. Further, as advancements have been made in downhole transmission assembly designs and the transmissions have been designed and configured to accommodate higher torque load transfers and higher power section fluid communication, seals and joints have become increasingly failure prone. Seal and joint failures have been determined to be, at least in part, attributable to the dynamic and turbulent flow of drilling fluid through the transmission assembly housing and adjacent to the transmission assembly's joint and drive shaft intersection points. To accommodate the increasingly large flow volumes of power section driving fluids and the turbulent flow through and over downhole transmission assemblies, it is thus desirable to improve transmission assemblies such that they can accommodate harsher environments while retaining reliability and reducing servicing downtime and expense. It is further desirable to improve the flow patterns of drilling fluid through transmission assembly housings such that joint seals and other fluid isolation components experience less degradation and wear over time and thus can achieve longer intervals between servicing.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a side cross-sectional view of a prior art transmission assembly.

FIG. 2 is a side cross-sectional view of a Streamlined Transmission assembly configured with a ball bearing style rotating joint.

FIG. 3 is a side cross-sectional view of a Streamlined Transmission assembly configured with a torque dowel style rotating joint.

FIG. 4 is an enlarged cross-sectional view of a portion of a Streamlined Transmission assembly shown in FIG. 3.

FIG. 5 is an enlarged cross-sectional view of a portion of a Streamlined Transmission assembly shown in FIG. 3.

FIG. 6 is a side perspective view of a Streamlined Transmission assembly.

FIG. 7 is a side perspective view of a CV shaft of a Streamlined Transmission assembly.

FIG. 8 is a side perspective view of a drive coupling of a Streamlined Transmission assembly.

FIG. 9 is a side perspective view of a male thrust pivot of a Streamlined Transmission assembly.

FIG. 10 is a side perspective view of a female thrust pivot of a Streamlined Transmission assembly.

FIG. 11 is a side perspective view of a torque dowel of a Streamlined Transmission assembly.

FIG. 12 is a side perspective view of a split seal ring of a Streamlined Transmission assembly.

FIG. 13 is a side perspective view of an adaptor cap of a Streamlined Transmission assembly.

FIG. 14 is a side perspective view of a seal boot of a Streamlined Transmission assembly.

FIG. 15 is a side perspective view of a rotor adaptor of a Streamlined Transmission assembly.

### DETAILED DESCRIPTION

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

A Streamlined Transmission assembly is used to convert eccentric rotation created by the power section into concentric rotation to be received by a bearing assembly in order to drive the rotation of a drill bit attached to a drilling assembly section of a downhole tool. The Streamlined Transmission assembly may also be configured to alter the angle of the bottom hole assembly by the use of a bent housing section. The Streamlined Transmission assembly can allow better fluid flow though the transmission section of the motor, and can transmit a high amount of torque without sacrificing mobility or strength in high degree bent housings. Another goal of the Streamlined Transmission is to reduce the deterioration of the seals and joints in the downhole portion of the transmission by reducing the amount of turbulent flow concentrated in the lower joint. The Streamlined Transmission can be configured with any style of joint including, for example, a ball bearing style joint or a torque dowel style joint assembly, both of which assist with the transmission of high amounts of torque while maintaining a good amount of mobility. While the preferred embodiments are described with joint configurations, other similar joints can be configured in a Streamlined Transmission assembly.

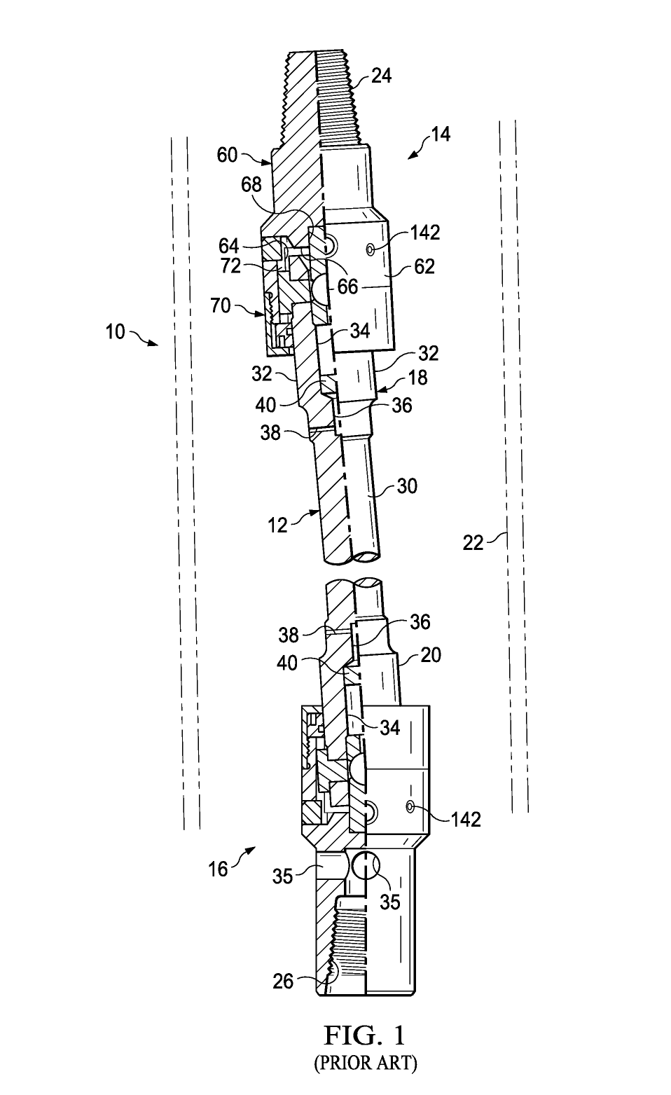

FIG. 1 is illustrative of a prior art transmission assembly having a traditional transmission and joint configuration. This type of transmission assembly is susceptible to turbulent flow patterns of drilling fluid through the transmission assembly housing due to the sharp angles and corners that the flow must traverse. In particular, as discussed in more detail below, a large portion of this turbulent flow is often caused by the orientation of the downhole joint of the transmission. Direct contact with these turbulent flow patterns are known to cause the degradation and wear of transmission assembly joint seals and/or other components that are configured to isolate the inner portions of a transmission assembly joint from the flow of drilling fluid. When transmission assembly joints break down over time, the joint itself may fail entirely or the transmission assembly may fail to work at its intended design torque and/or other intended specifications. This sort of breakdown can then cause significant downtime to occur where the entire downhole drilling assembly must be brought back to be serviced so the failing and/or degraded seals or other components can be replaced. The washed out rubber from the seals can also travel to and interfere with the components and may can also be mistaken for stator rubber, leading to a false indication of stator chunking and/or de-bonding. Further, once the seals have been washed out, abrasive drilling fluid can enter the joint cavity, which can accelerate the rate of wear on joint components, leading to reduced life of the downhole drilling assembly. In turn, the downtime caused by the need to regularly service seal assemblies and other related components can be extremely costly to well operators. It is thus desirable to increase the average deployment time of a transmission assembly and reduce transmission assembly servicing requirements.

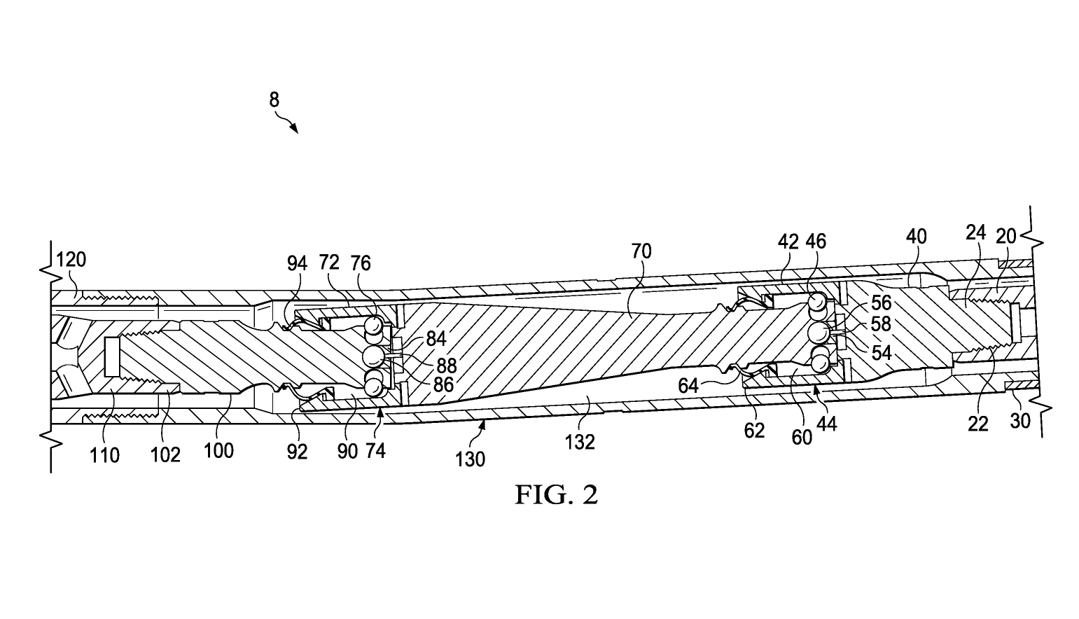

The Streamlined Transmission assembly design seeks to reduce the problem of turbulent fluid flow and the effects, such as degradation and seal failure, that turbulent flow has on joint seal assemblies and other components that are configured to isolate the inner portions of transmission assembly joints. Referring to FIG. 1, as the drilling fluid is pumped downhole, the configuration of the prior art seal assemblies and especially the orientation of the downhole seal assembly, placing the seal itself in the direct path of fluid flow, causes the seal to experience consistent degrading contact with more turbulent drilling fluid than a Streamlined Transmission assembly seal experiences over time. Referring to an embodiment of the Streamlined Transmission assembly, such as is illustrated in FIG. 2, it is apparent that the fluid flow patterns are more streamlined through the transmission assembly housing and that the orientation of the seals for the configured joints will reduce the exposure to turbulent fluid flow for the seals, particularly in the downhole portion of the transmission.

Again referring to FIG. 2, an embodiment of a Streamlined Transmission assembly 8 is shown, as configured with a ball bearing style rotating joint 44. The Streamlined Transmission 8 is connected to a rotor 20 and stator 30 by a threaded rotor to transmission coupling section 22. The rotor 20 connects to the rotor adaptor 40 of the Streamlined Transmission 8 by a threaded coupling section 22 of the rotor to transmission coupling section 24. The drill bit facing section of the rotor adaptor 40 includes a drill bit facing cup section 42 that, in this embodiment, is configured to accommodate a ball bearing style rotating joint 44. The ball bearing style rotating joint 44 included in this embodiment can be configured to include multiple ball bearings 46, a female thrust pivot 54, a male thrust pivot 56, an alignment pin 58, a split seal ring 60, an adaptor cap 62, and a seal boot 64.

Attached to the ball bearing style rotating joint 44 is a constant velocity (CV) Shaft 70 that transmits torque received from the rotor to transmission coupling section 22 and ball bearing style rotating joint 44 to a second ball bearing style rotating joint 74 that is coupled to a drive coupling 100. The end of the CV Shaft 70 that attaches to the ball bearing style rotating joint 44 can be referred to as the first jointed end of the CV Shaft 70. The CV Shaft 70 includes a cup section 72 that, in this embodiment, is configured to accommodate the second ball bearing style joint 74. The end of the CV Shaft 70 that attaches to the second ball bearing style rotating joint 74 can be referred to as the second jointed end of the CV Shaft 70. Thus, in an embodiment, the CV Shaft 70 can be configured to have two jointed ends. Unlike in the prior art designs such as shown in FIG. 1, cup section 72 faces the drill bit, as does cup section 42 in the uphole portion of the transmission. This orientation of downhole cup section 72 allows CV shaft 70 to have the streamlined generally frustoconical shape shown in FIG. 2, as opposed to the generally cylindrical shape of CV shaft 30 shown in FIG. 1. The streamlined generally frustoconical shape of CV shaft 70 eliminates some of the sharp angles and corners referenced above which contribute to turbulent fluid flow and degradation and wear of transmission assembly joint seals and/or other components that are configured to isolate the inner portions of a transmission assembly joint from the flow of drilling fluid

The second ball bearing style rotating joint 74 included in this embodiment can be configured to include multiple ball bearings 76, a female thrust pivot 84, a male thrust pivot 86, an alignment pin 88, a split seal ring 90, an adaptor cap 92, and a seal boot 94. Attached to the second ball bearing style rotating joint 74 is a drive coupling 100 that transmits torque received through the second ball bearing style rotating joint 74. The end of the drive coupling 100 that attaches to the second ball bearing style rotating joint 74 can be referred to as the jointed end of the drive coupling 100. The torque transmitted into drive coupling 100 is further transmitted to a flow diverter section 110 of the thrust section housing 120. The drive coupling 100 is shown configured with a drive coupling to flow diverter threaded coupling section 102, through which torque is transferred by the Streamlined Transmission assembly 8 to the thrust section.

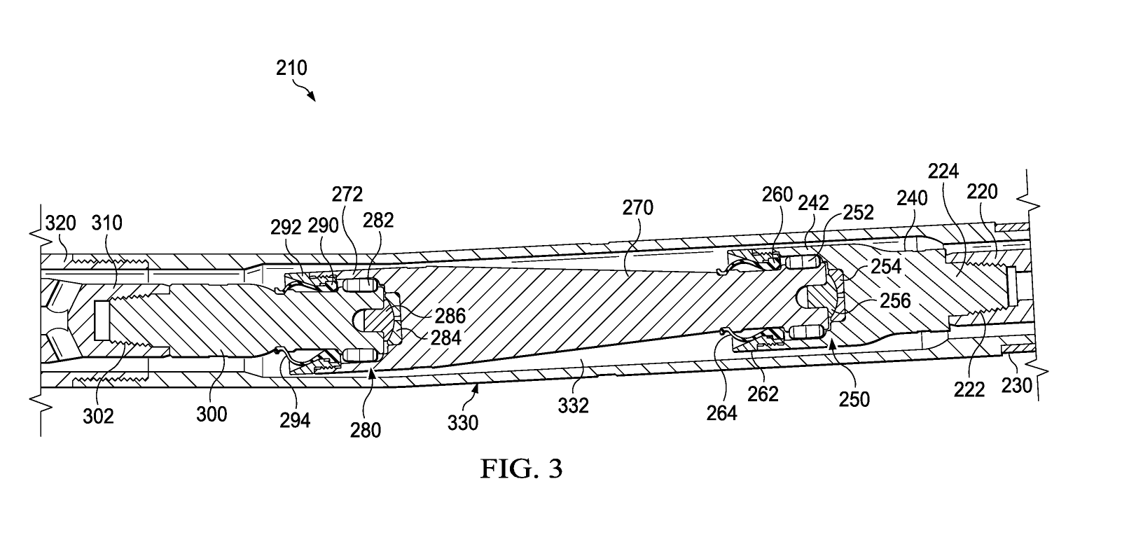

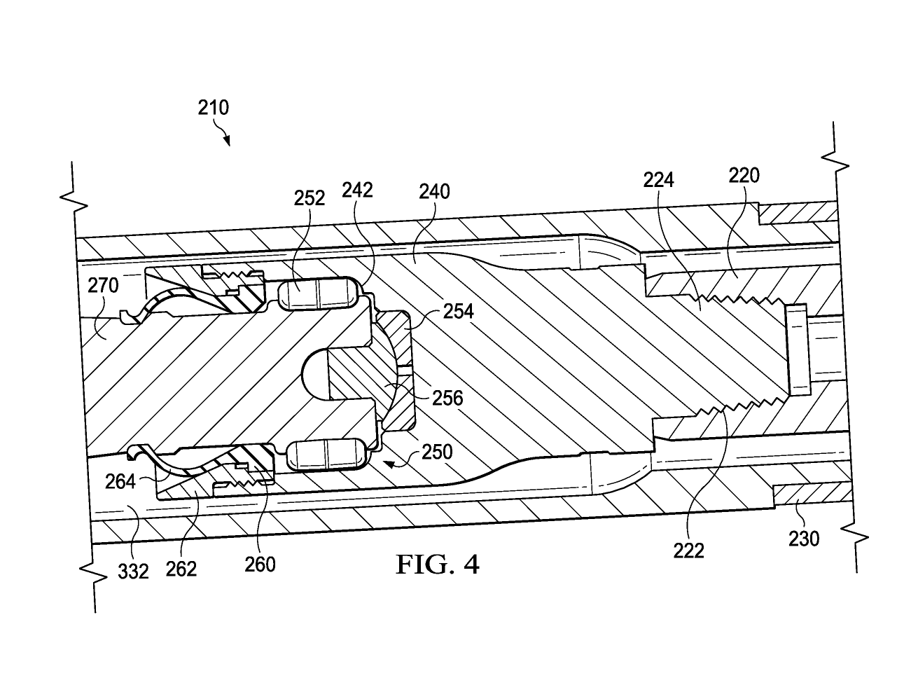

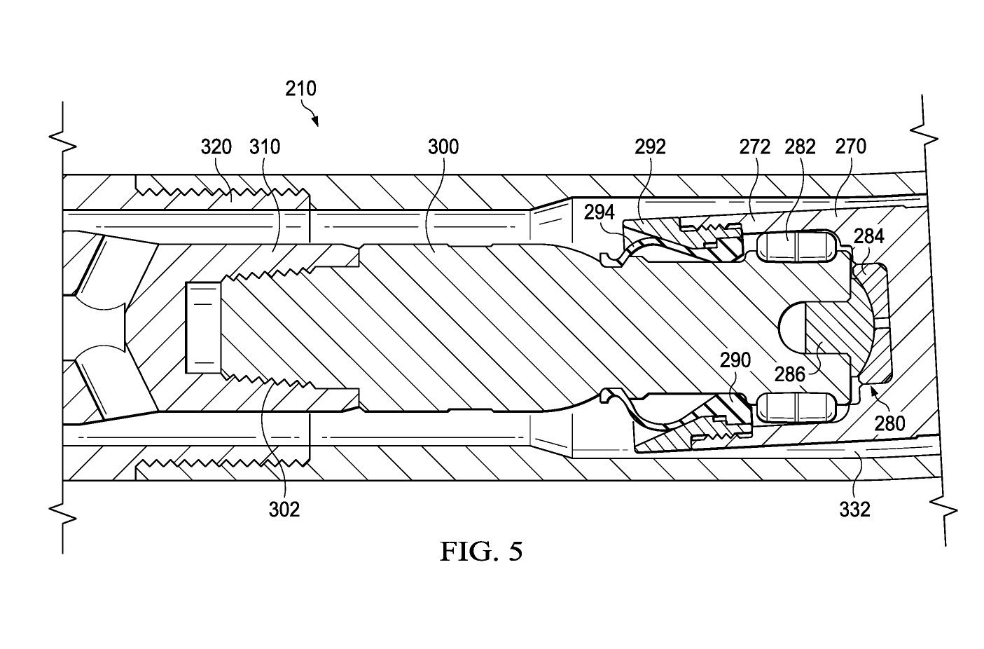

Referring to FIGS. 3-5, another embodiment of a Streamlined Transmission assembly 210 is shown. The Streamlined Transmission 210 is connected a rotor 220 and stator 230 by a threaded rotor to transmission coupling section 222. The rotor 220 connects to the rotor adaptor 240 of the Streamlined Transmission 210 by a threaded coupling section 222 of the rotor to transmission coupling section 224. The drill bit facing section of the rotor adaptor 240 includes a drill bit facing cup section 242 that, in this embodiment, is configured to accommodate a torque dowel style rotating joint 250. The torque dowel style rotating joint 250, includes in this embodiment and can be configured to include, multiple torque dowels 252, a female thrust pivot 254, a male thrust pivot 256, a split seal ring 260, an adaptor cap 262, and a seal boot 264.

Attached to the torque dowel style joint rotating 250 is a CV Shaft 270 that transmits torque received from the rotor to transmission coupling section 222 and torque dowel style rotating joint 250 to a second torque dowel style rotating joint 280 that is coupled to a drive coupling 300. The CV Shaft 270 includes a CV Shaft drill bit facing cup section 272 that, in this embodiment, is configured to accommodate the second torque dowel style rotating joint 280. The second torque dowel style rotating joint 280, includes in this embodiment and can be configured to include, multiple torque dowels 282, a female thrust pivot 284, a male thrust pivot 286, a split seal ring 290, an adaptor cap 292, and a seal boot 294. The torque transmitted into drive coupling 300 is further transmitted to a flow diverter section 310 of the thrust section housing 320. The drive coupling 300 is shown configured with a drive coupling to flow diverter threaded coupling section 302, through which torque is transferred by the Streamlined Transmission assembly 210 to the thrust section

In a preferred embodiment the seal boot 264 and the seal boot 294 can be made of rubber. In other alternative embodiments the seal boot 264 and the seal boot 294 can be made of other suitable materials. The seal boots are intended to substantially prevent drilling fluid from contacting the rotating joints of the assembly.

As illustrated in FIGS. 3-5, both the torque dowel style rotating joint 250 and the second torque dowel style rotating joint 280, allow for the reliable transmission of torque through an angled portion of the bent housing section 330 of the Streamlined Transmission assembly 210. Further, both the drill bit facing cup section 242 of the rotor adaptor 240 and the CV Shaft drill bit facing cup section 272, allow the placement and orientation of their respective seal rings, split seal ring 260 and split seal ring 290, to face away from the direct flow path of the flow cavity 332. These seals as well as the components they protect are susceptible to wear and breakdown from drilling fluid and any particulate matter or debris it contains, especially when exposed to turbulent flow patterns. With the illustrated and described configuration of the Streamlined Transmission, the wear rate and breakdown rate of the transmission seals and joints of the Streamlined Transmission should be reduced when compared to other known transmissions, resulting in greater longevity of the Streamlined Transmission and longer intervals between servicing or rebuilding of the transmission. As the entire drilling assembly needs to be brought to the surface for servicing or repair work, the benefits of longer intervals between servicing are great.

In an embodiment, other rotating joints besides ball bearing style rotating joints and torque dowel style rotating joints can be substituted for the joints described herein. For example, key style or claw coupling style joints, such as those described in U.S. Pat. No. 4,772,246 to Wenzel, can be substituted and still provide similar torque transmission and adjustment angles through the bent housing section of the Streamlined Transmission assembly.

In another alternative embodiment, multiple joint styles may be configured within one streamlined transmission assembly. For example, one ball bearing style joint can be configured and a secondary torque dowel style joint can be configured within the same Streamlined Transmission assembly. Similarly other combinations of joints can be configured, such that optimized configurations can be achieved for a particular downhole environment or, for example, to accommodate a particular transmission assembly servicing schedule or plan.

In an embodiment, and as illustrated in FIG. 6, both the drill bit facing cup section 242 of the rotor adaptor 240 and the CV Shaft drill bit facing cup section 272 can optionally be configured with an outward facing grease insertion point 340 by which grease can be inserted into the inner dowel style joint facing cup cavities of the respective sections. In an embodiment a plug can be configured to seal the greased section after grease has been inserted.

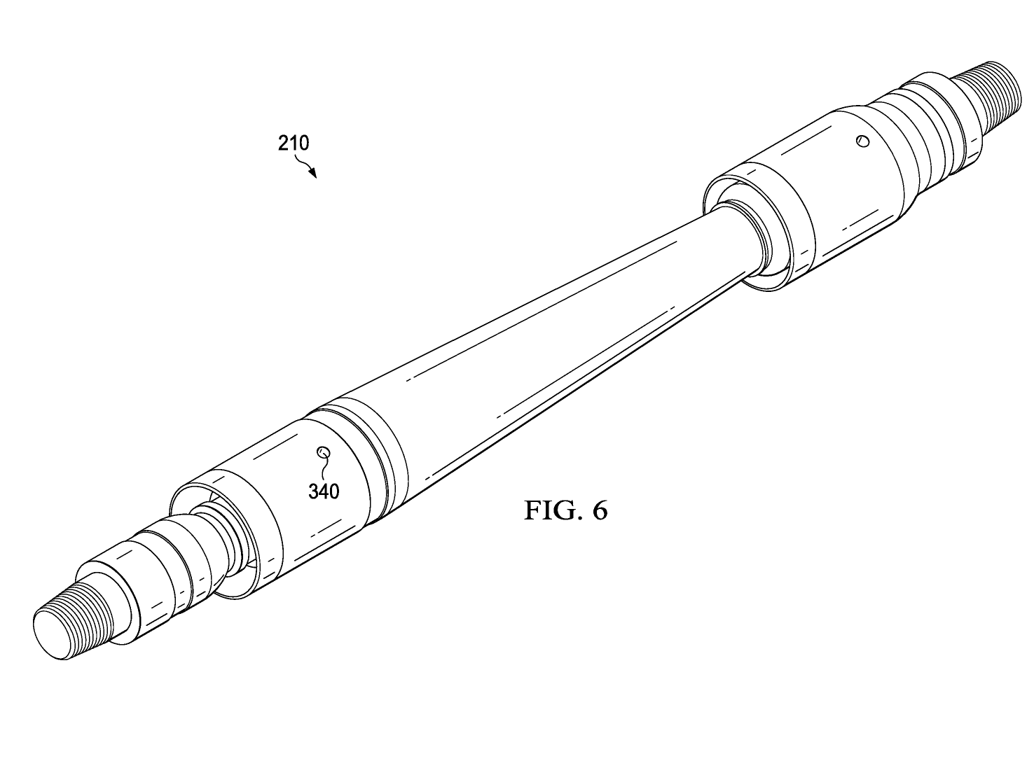

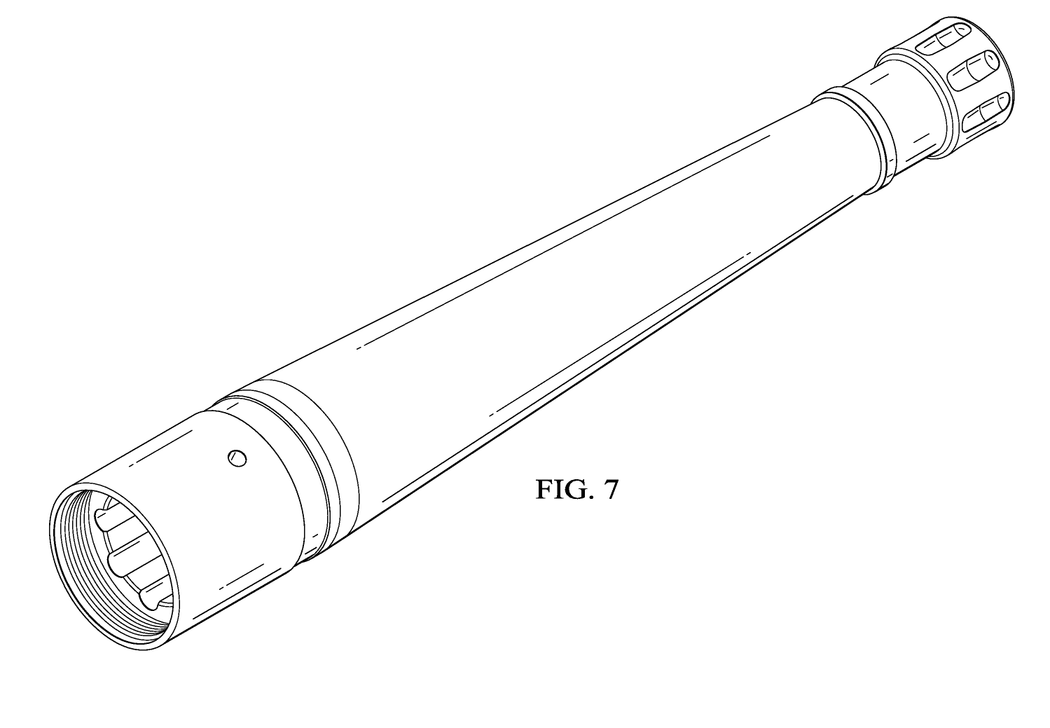

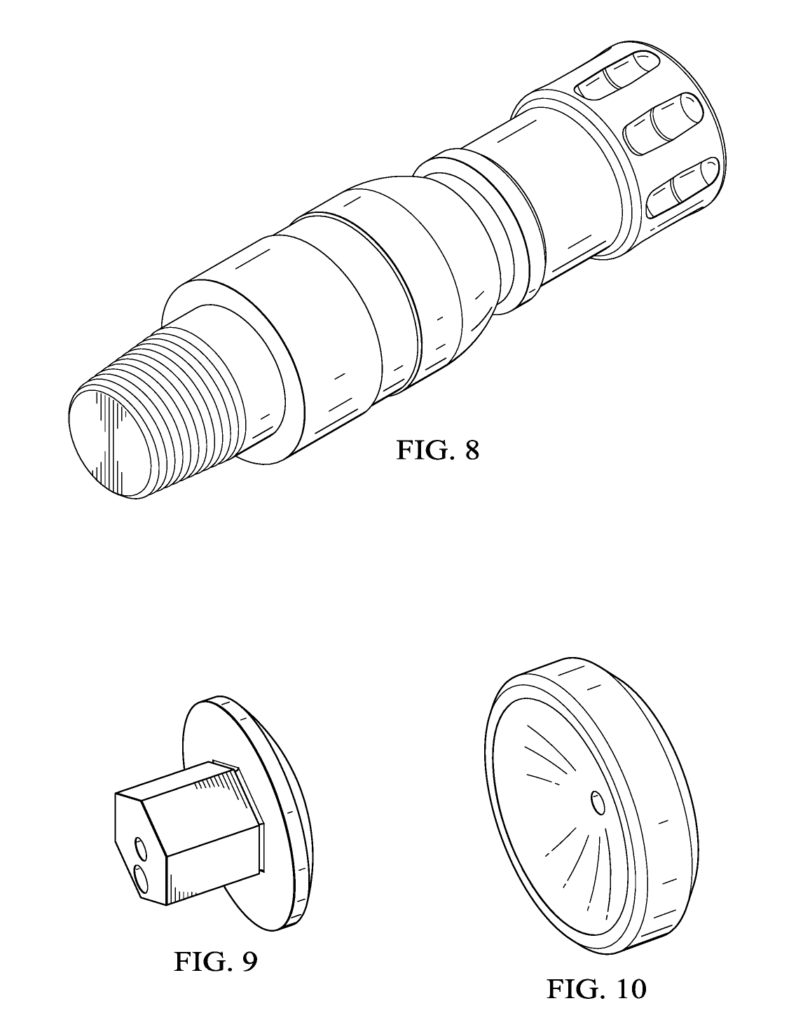

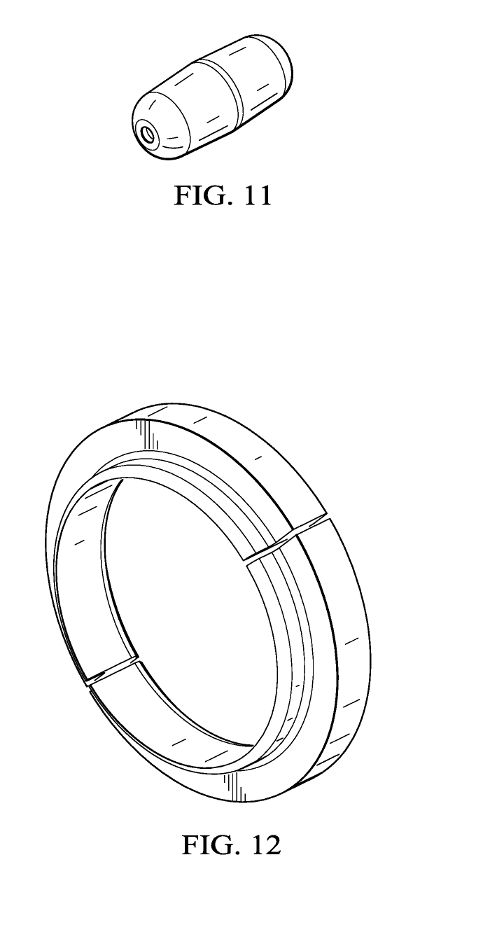

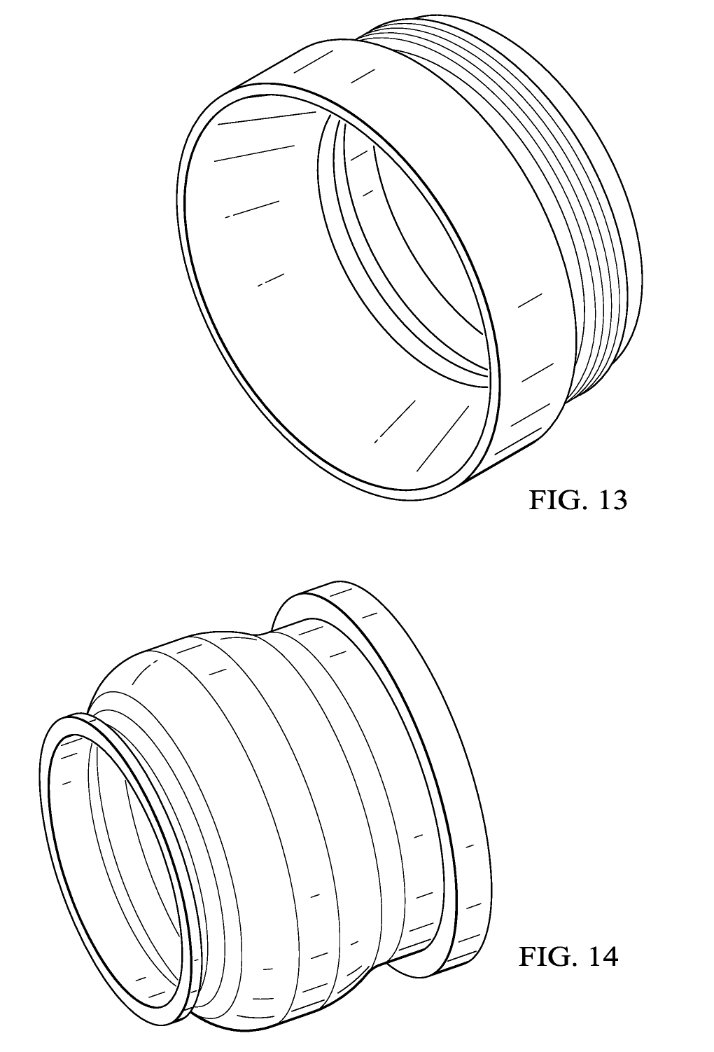

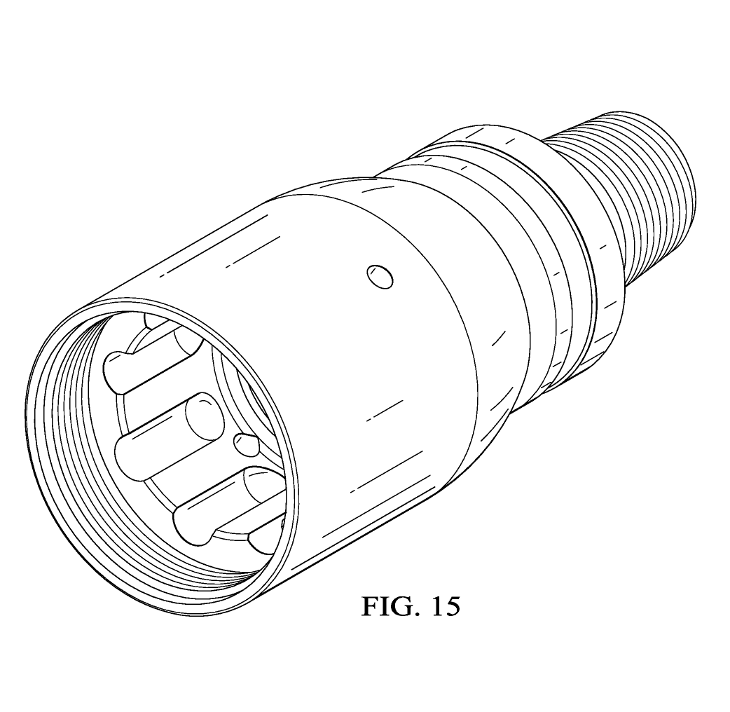

FIGS. 6 through 15, illustrate side perspective views of embodiments of the individual components previously discussed.

1. A downhole power section transmission comprising:
a rotor, a CV shaft, and a drive coupling, configured such that the rotor transmits torque to the CV shaft, the CV shaft transmits torque to the drive coupling, and the drive coupling transmits torque to other downhole components to drive rotation of a drill bit;
the rotor further comprising a rotor adaptor configured with a first drill bit facing cup section,
the CV shaft connected to the rotor adaptor at the first drill bit facing cup section through a first rotating joint;
the CV shaft further comprising a second drill bit facing cup section,
the drive coupling connected to the CV shaft at the second drill bit facing cup section through a second rotating joint; and
the drive coupling configured to couple with a thrust receiving section of a downhole drill bit assembly.

2. The downhole power section transmission of claim 1 wherein the first rotating joint comprises a ball bearing style rotating joint.

3. The downhole power section transmission of claim 2 wherein the second rotating joint comprises a ball bearing style rotating joint.

4. The downhole power section transmission of claim 1 wherein the first rotating joint comprises a torque dowel style rotating joint.

5. The downhole power section transmission of claim 4 wherein the second rotating joint comprises a torque dowel style rotating joint.

6. The downhole power section transmission of claim 1 wherein the first drill bit facing cup section comprises a first seal boot.

7. The downhole power section transmission of claim 6 wherein the second drill bit facing cup section comprises a second seal boot.

8. The downhole power section transmission of claim 5, further comprising:
a first female thrust pivot connected to the rotor adapter; and
a first end cap between the CV shaft and the first female thrust pivot.

9. The downhole power section transmission of claim 8, further comprising:
a second female thrust pivot connected the CV shaft; and
a second end cap between the drive coupling and the second female thrust pivot.

10. The downhole power section transmission of claim 7 wherein the first seal boot and the second seal boot are comprised of rubber.

11. A method of downhole drilling comprising the following steps:
configuring a drill string with a power section transmission, the power section transmission comprising:
a rotor, a CV shaft, and a drive coupling, configured such that the rotor transmits torque to the CV shaft, the CV shaft transmits torque to the drive coupling, and the drive coupling transmits torque to other downhole components to drive rotation of a drill bit;
the rotor further comprising a rotor adaptor configured with a first drill bit facing cup section,
the CV shaft connected to the rotor adaptor at the first drill bit facing cup section through a first rotating joint,
the CV shaft further comprising a second drill bit facing cup section,
the drive coupling connected to the CV shaft at the second drill bit facing cup section through a second rotating joint, and
the drive coupling configured to couple with a thrust receiving section of a downhole drill bit assembly
deploying the drill string downhole;
applying power to the drill string such that torque is transmitted to the power section transmission from a power section, thereby causing the power section transmission to transmit torque to the thrust receiving section of the downhole drill bit assembly.

12. The method of downhole drilling of claim 12, wherein the first rotating joint of the power section transmission comprises a ball bearing style rotating joint and the second rotating joint of the power section transmission comprises a ball bearing style rotating joint.

13. The method of downhole drilling of claim 12, wherein the first rotating joint of the power section transmission comprises a torque dowel style rotating joint and the second rotating joint of the power section transmission comprises a torque dowel style rotating joint.

14. The method of downhole drilling of claim 12, wherein the first drill bit facing cup section comprises a first seal boot and the second drill bit facing cup section comprises a second seal boot.

15. The method of downhole drilling of claim 14, wherein the power section transmission further comprises:
a first female thrust pivot connected to the rotor adaptor;
a first end cap between the CV shaft and the first female thrust pivot;
a second female thrust pivot connected to the CV shaft; and
a second end cap between the drive coupling and the second female thrust pivot.

16. The method of downhole drilling of claim 15, wherein the first seal boot and the second seal boot are comprised of rubber.
